(19) United States
(12) Patent Application Publication
(10) Pub. No.: US 2025/0102977 A1
(43) Pub. Date: Mar. 27, 2025

(54) FIXING DEVICE AND IMAGE FORMING SYSTEM

(71) Applicant: FUJIFILM Business Innovation Corp., Tokyo (JP)

(72) Inventors: Takayuki UKAWA, Kanagawa (JP); Hideki KUGE, Kanagawa (JP); Yoshiki SHIMODAIRA, Kanagawa (JP); Masato YAMASHITA, Kanagawa (JP); Takayuki YAMASHITA, Kanagawa (JP); Yutaka KIUCHI, Kanagawa (JP)

(73) Assignee: FUJIFILM Business Innovation Corp., Tokyo (JP)

(21) Appl. No.: 18/594,744

(22) Filed: Mar. 4, 2024

(30) Foreign Application Priority Data
Sep. 25, 2023 (JP) 2023-161724

(51) Int. Cl. G03G 15/20; G03G 15/00

(52) U.S. Cl. CPC G03G 15/2039; G03G 15/2032; G03G 15/5016; G03G 15/5029; G03G 2215/2061

(57) ABSTRACT

A fixing device includes a heating member configured to heat a toner image on a front surface of a recording medium; a pressing member having an outer circumferential surface formed with a concave portion into which a gripping portion configured to grip a front end side of the recording medium enters, the pressing member being configured to rotate and press the recording medium together with the heating member; a moving portion configured to cause the heating member and the pressing member to relatively move between a position where the heating member comes into contact with the outer circumferential surface of the pressing member directly or via the recording medium and a position where the heating member moves away from the outer circumferential surface of the pressing member when the concave portion passes; and a switching portion configured to switch, between high and low, a load to be applied to a contact portion between the heating member and the outer circumferential surface of the pressing member in accordance with a type of the recording medium or a selection by a user.

### CROSS-REFERENCE TO RELATED APPLICATIONS

This application is based on and claims priority under 35 USC 119 from Japanese Patent Application No. 2023-161724 filed Sep. 25, 2023.

### BACKGROUND

### (i) Technical Field

The present disclosure relates to a fixing device and an image forming system.

### (ii) Related Art

Japanese Unexamined Patent Application Publication No. 2021-114000 discloses an image forming apparatus including: a heating rotator and a pressing rotator between which a nip portion is provided to pinch and convey a recording material to heat a toner image on the recording material; a pressing mechanism configured to press at least one of the heating rotator and the pressing rotator toward the other one of the heating rotator and the pressing rotator; a pressing force switching mechanism configured to switch a pressing force of the nip portion by the pressing mechanism, a temperature-control temperature switching portion configured to switch a temperature-control temperature for the heating rotator; a conveying speed switching portion configured to switch a conveying speed for the recording material by the nip portion; a display portion configured to display information; a setting portion displayed on the display portion, on which an operator sets a correction level for wrinkles on an envelope; and an execution portion configured to switch at least one setting of the pressing force, the temperature-control temperature, and the conveying speed in accordance with the correction level set on the setting portion and a width of the envelope, respectively, to execute heating on a toner image on the envelope.

### SUMMARY

Aspects of non-limiting embodiments of the present disclosure relate to a fixing device and an image forming system that make it possible, compared with a case where a load to be applied to a contact portion between a heating member and a pressing member is always constant, to suppress deterioration in image quality due to vibration that occurs when the heating member comes into contact with the pressing member or to secure a fully fixed, high gloss toner image on a recording medium in accordance with a type of the recording medium or required image quality.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a fixing device including a heating member configured to heat a toner image on a front surface of a recording medium; a pressing member having an outer circumferential surface formed with a concave portion into which a gripping portion configured to grip a front end side of the recording medium enters, the pressing member being configured to rotate and press the recording medium together with the heating member; a moving portion configured to cause the heating member and the pressing member to relatively move between a position where the heating member comes into contact with the outer circumferential surface of the pressing member directly or via the recording medium and a position where the heating member moves away from the outer circumferential surface of the pressing member when the concave portion passes; and a switching portion configured to switch, between high and low, a load to be applied to a contact portion between the heating member and the outer circumferential surface of the pressing member in accordance with a type of the recording medium or a selection by a user.

### BRIEF DESCRIPTION OF THE DRAWINGS

An exemplary embodiment of the present disclosure will be described in detail based on the following figures, wherein:

FIG. 1 is a schematic configurational diagram illustrating an example of an image forming system including a fixing device according to a first exemplary embodiment;

FIG. 2 is a schematic configurational diagram illustrating a toner image forming portion in the image forming system including the fixing device according to the first exemplary embodiment;

FIG. 3 is a configurational diagram illustrating the fixing device according to the first exemplary embodiment;

FIG. 4 is a configurational diagram illustrating a part of a fixing unit in the fixing device according to the first exemplary embodiment;

FIG. 5 is a block diagram illustrating an example of a hardware configuration of the fixing device according to the first exemplary embodiment;

FIG. 6 is a front view illustrating a moving portion in the fixing unit, which is used in the fixing device according to the first exemplary embodiment;

FIG. 7 is a perspective view illustrating a configuration around a camshaft in the moving portion in the fixing unit;

FIG. 8A is a front view illustrating an arrangement when the fixing unit is in a full separation state;

FIG. 8B is an enlarged view illustrating a situation around the camshaft when the fixing unit is in the full separation state;

FIG. 9A is a front view illustrating an arrangement when the fixing unit is in a home position;

FIG. 9B is an enlarged view illustrating a situation around the camshaft when the fixing unit is in the home position;

FIG. 10A is a front view illustrating an arrangement when a low load is applied in the fixing unit;

FIG. 10B is an enlarged view illustrating a situation around the camshaft when the low load is applied in the fixing unit;

FIG. 11A is a front view illustrating an arrangement when a high load is applied in the fixing unit;

FIG. 11B is an enlarged view illustrating a situation around the camshaft when the high load is applied in the fixing unit; and

FIG. 12 is a diagram illustrating a relationship among a load in the fixing unit, a heat amount that a preheating portion applies, and required quality.

### DETAILED DESCRIPTION

An example of an exemplary embodiment of the present disclosure will now be described herein with reference to the accompanying drawings. Note that, an arrow H illustrated in each of the drawings indicates a perpendicular direction and an upper-lower direction of a device, an arrow W indicates a horizontal direction and a width direction of the device, and an arrow D indicates a front-rear direction of the device (a depth direction of the device).

### First Exemplary Embodiment

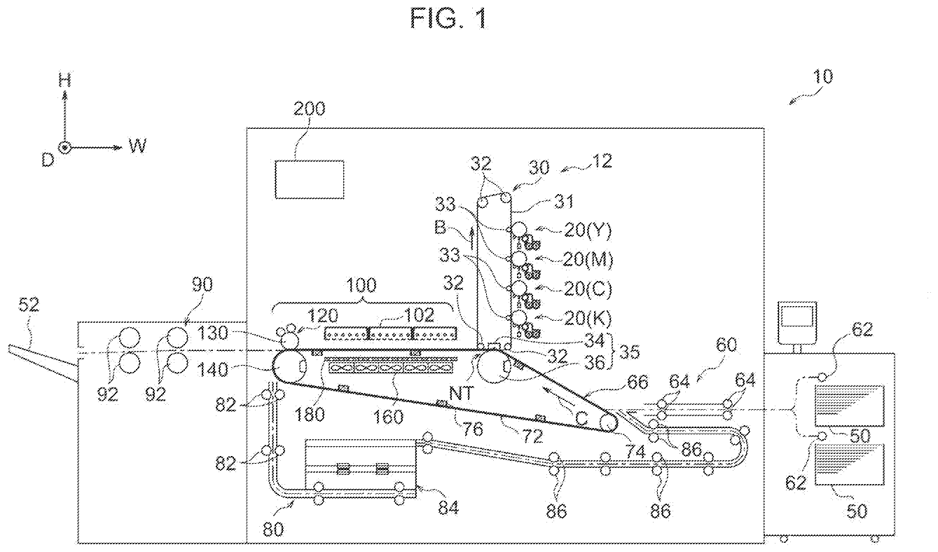

A configuration of an image forming system 10 including a fixing device 100 according to a first exemplary embodiment will now first be described herein. FIG. 1 is a schematic diagram illustrating the configuration of the image forming system 10 according to the first exemplary embodiment.

### Image Forming System

The image forming system 10 illustrated in FIG. 1 is an electrophotographic type image forming system that forms a toner image on a sheet P serving as an example of a recording medium. Specifically, as illustrated in FIG. 1, the image forming system 10 includes accommodation portions 50, a discharge portion 52, an image forming portion 12, a conveying mechanism 60, a reversing mechanism 80, the fixing device 100, and a cooling portion 90. Furthermore, the image forming system 10 includes a control device 200 that controls each component in the image forming system 10.

### Accommodation Portions

The accommodation portions 50 illustrated in FIG. 1 each have a function of accommodating sheets P. In the image forming system 10, the accommodation portions 50 are provided in plural (for example, two). The sheets P are selectively fed from the plurality of accommodation portions 50. As sheets P, flat sheets (cut sheets) each having a predetermined dimension (size) are used.

### Discharge Portion

The discharge portion 52 illustrated in FIG. 1 is a portion to which a sheet P formed with an image is discharged. Specifically, a sheet P having an image fixed by the fixing device 100 and cooled by the cooling portion 90 is discharged to the discharge portion 52.

### Image Forming Portion

The image forming portion 12 illustrated in FIG. 1 is an example of an image forming portion that forms an image on a recording medium. Specifically, the image forming portion 12 has a function of using an electrophotographic method to form a toner image on a sheet P. More specifically, as illustrated in FIG. 1, the image forming portion 12 includes toner image forming portions 20 that each form a toner image and a transfer device 30 that transfers the toner images formed by the toner image forming portions 20 to a sheet P.

### Toner Image Forming Portions

The toner image forming portions 20 are provided in plural to each form a toner image in each color. The image forming system 10 includes the toner image forming portions 20 corresponding to a total of four colors including yellow (Y), magenta (M), cyan (C), and black (K), respectively. FIG. 1 illustrates (Y), (M), (C), and (K) representing the components corresponding to the colors described above, respectively.

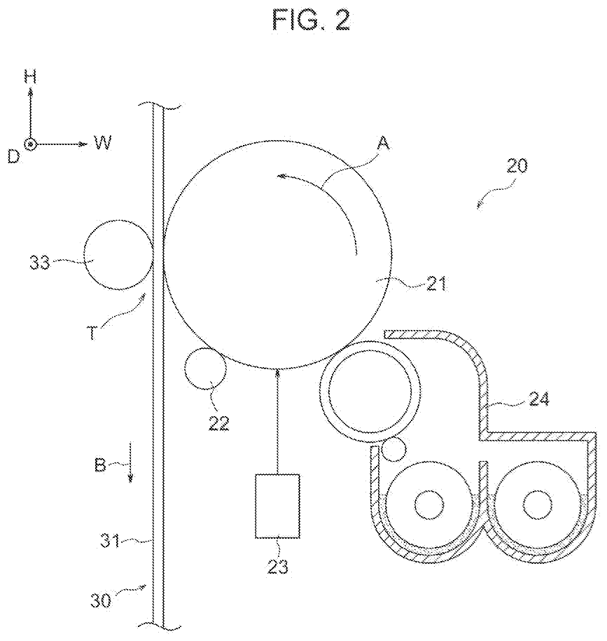

The toner image forming portions 20 corresponding to the colors, respectively, are basically formed identical to each other excluding toners to be used. Specifically, as illustrated in FIG. 2, the toner image forming portions 20 corresponding to the colors, respectively, each include a photoconductor drum 21 (a photoconductor) that rotates in a direction that an arrow A indicates in FIG. 2, and a charging device 22 that causes the photoconductor drum 21 to charge electricity. Furthermore, the toner image forming portions 20 corresponding to the colors, respectively, each include an exposure device 23 that causes the photoconductor drum 21 charged with electricity by the charging device 22 to be exposed to form an electrostatic latent image on the photoconductor drum 21, and a developing device 24 that causes the electrostatic latent image that the exposure device 23 has formed on the photoconductor drum 21 to be developed to form a toner image.

### Transfer Device

The transfer device 30 illustrated in FIG. 1 has a function of superimposing and primarily transferring toner images on the photoconductor drums 21 corresponding to the colors, respectively, to an intermediate transfer body, and of secondarily transferring the superimposed toner images to a sheet P. Specifically, as illustrated in FIG. 1, the transfer device 30 includes a transfer belt 31 serving as the intermediate transfer body, primary transfer rolls 33, and a transfer portion 35.

The primary transfer rolls 33 each have a function of transferring a toner image formed on the photoconductor drum 21 to the transfer belt 31 at a primary transfer position T (see FIG. 2) between the photoconductor drum 21 and the primary transfer roll 33.

As illustrated in FIG. 1, the transfer belt 31 has an endless shape, and is wound around a plurality of rolls 32 to determine its posture. When at least one of the plurality of rolls 32 is driven and rotated, the transfer belt 31 moves in a circulation manner in a direction that an arrow B indicates, and conveys the primarily transferred image to a secondary transfer position NT.

The transfer portion 35 has a function of transferring the toner image transferred to the transfer belt 31 to a sheet P. Specifically, the transfer portion 35 includes a secondary transfer portion 34 and a counter roll 36.

The counter roll 36 is disposed below the transfer belt 31 to face the transfer belt 31. As illustrated in FIG. 1, the secondary transfer portion 34 is disposed in a space that the transfer belt 31 forms to pinch and dispose the transfer belt 31 together with the counter roll 36. As an example, the secondary transfer portion 34 includes a corotron. In the transfer portion 35, an electrostatic force generated by electricity discharged from the secondary transfer portion 34 causes the toner image transferred to the transfer belt 31 to be transferred to a sheet P passing through the secondary transfer position NT.

### Conveying Mechanism

The conveying mechanism 60 illustrated in FIG. 1 is a mechanism that conveys a sheet P. Specifically, the conveying mechanism 60 has a function of conveying a sheet P accommodated in the accommodation portions 50 to the secondary transfer position NT. Furthermore, the conveying mechanism 60 has a function of conveying the sheet P from the secondary transfer position NT to a fixing unit 120 described later (a heating roll 130 and a pressing roll 140 described later). In other words, the conveying mechanism 60 has a function of conveying, in the fixing device 100, a sheet P transferred with a toner image.

Specifically, as illustrated in FIG. 1, the conveying mechanism 60 includes sending rolls 62, a plurality of conveying rolls 64, and a chain gripper 66. The sending rolls 62 are rolls that each send a sheet P accommodated in the accommodation portions 50. The plurality of conveying rolls 64 are rolls that convey the sheet P that the sending rolls 62 has sent to the chain gripper 66.

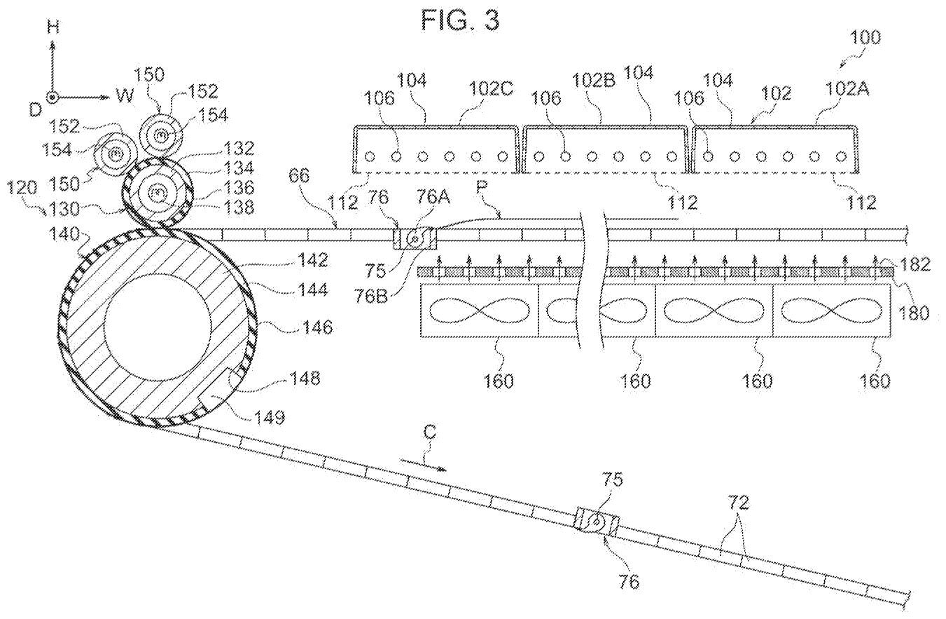

As illustrated in FIG. 3, the chain gripper 66 is an example of a conveyance portion that holds a front end side (a tip side) of a sheet P and conveys the sheet P. Specifically, the chain gripper 66 includes a pair of pieces of chain 72 and grippers 76 each serving as an example of a gripping portion (a holding portion).

As illustrated in FIG. 1, the pair of pieces of chain 72 are each formed in a ring shape. The pair of pieces of chain 72 are disposed at an interval in the front-rear direction of the device (the D direction in FIG. 1). Then, the pair of pieces of chain 72 are each wound around a pair of sprockets (not illustrated) disposed on one end side and another end side in an axial direction with respect to each of the counter roll 36 and the pressing roll 140 described later and a pair of sprockets 74 disposed at an interval in the front-rear direction of the device. As one of the pair of sprockets rotates in the configuration, the pieces of chain 72 move in a circulation manner in a direction that an arrow C indicates (see FIG. 1).

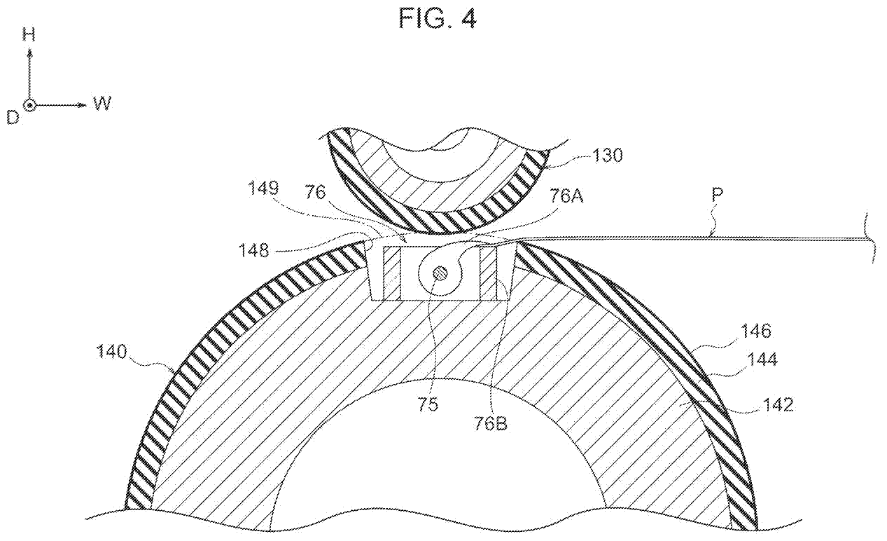

Attachment members 75 (see FIG. 4) attached with the grippers 76, respectively, bridge the pair of pieces of chain 72 in the front-rear direction of the device. A plurality of the attachment members 75 are fixed to the pair of pieces of chain 72 at predetermined intervals in a circumferential direction (a circulation direction) of the pieces of chain 72. Note that each of the drawings illustrates constituent portions of the pieces of chain 72 in blocks to simply illustrate the pieces of chain 72.

The plurality of grippers 76 are attached to the attachment members 75, respectively, at a predetermined interval in the front-rear direction of the device (see FIG. 3). The grippers 76 each have a function of holding (gripping) the front end portion of a sheet P. Holding the front end portion of a sheet P facilitates determination of a position of the sheet P in the conveyance direction for the sheet, and facilitates alignment (registration) of the sheet P and an image in the transfer portion 35. Specifically, as illustrated in FIGS. 3 and 4, the grippers 76 each include a pawl 76A and a pawl base 76B. The grippers 76 are each configured to allow the front end portion of a sheet P to be pinched between the pawl 76A and the pawl base 76B to hold the sheet P. Note that, in the grippers 76, a spring presses the pawl 76A against the pawl base 76B, and, as a cam is activated, the pawl 76A is opened and closed with respect to the pawl base 76B, for example.

Then, with the chain gripper 66, the pieces of chain 72 move in a circulation manner in the direction that the arrow C indicates in a state where one of the grippers 76 holds the front end portion of a sheet P to convey the sheet P. The chain gripper 66 conveys the sheet P to the secondary transfer position NT in a state where a first surface which is an example of the front surface of the sheet P faces upward, causes the sheet P to pass through a preheating portion 102 described later, and further conveys the sheet P to the fixing unit 120 described later. As described above, the chain gripper 66 is a portion having a function of holding, causing, to pass through the preheating portion 102, and conveying a sheet P from the preheating portion 102 to the fixing unit 120, and serves as part of the fixing device 100. Note that a part of a conveyance path along which a sheet P is conveyed in the conveying mechanism 60 is indicated by a one-dot chain line in FIG. 1.

### Reversing Mechanism

The reversing mechanism 80 illustrated in FIG. 1 is a mechanism for reversing the front surface and a back surface of a sheet P on which the fixing device 100 has fixed a toner image. More specifically, as illustrated in FIG. 1, the reversing mechanism 80 includes a plurality of (for example, two) conveying rolls 82, a reversing device 84, and a plurality of (for example, seven) conveying rolls 86.

The plurality of conveying rolls 82 are rolls that convey a sheet P sent from the fixing device 100 to the reversing device 84. As an example, the reversing device 84 is a device that allows, to be curved a plurality of times, and conveys a sheet P to change the conveyance direction for the sheet P each at an angle of 90 degrees to twist the sheet P like a Moebius strip to reverse the front surface and the back surface of the sheet P. The plurality of conveying rolls 86 are rolls that convey the sheet P, the front surface and the back surface of which has been reversed by the reversing device 84, to the chain gripper 66.

As described above, as the reversing mechanism 80 delivers the sheet P to the chain gripper 66, while reversing the front surface and the back surface, the chain gripper 66 conveys the delivered sheet P as the sheet P having fixed with a toner image on the first surface. In FIG. 1, a part of the conveyance path along which a sheet P is conveyed in the reversing mechanism 80 is indicated by a one-dot chain line. Note that, in the image forming system 10, it is not necessary to always provide the reversing mechanism 80, and the reversing mechanism 80 may be omitted.

### Fixing Device

The fixing device 100 illustrated in FIG. 3 is an example of a fixing device that causes an image that the image forming portion forms to be fixed to a recording medium. Specifically, the fixing device 100 is a device that causes a toner image that the transfer device 30 transfers to be fixed to a sheet P.

As illustrated in FIG. 1, the fixing device 100 is disposed on a downstream side of the secondary transfer position NT in the conveyance direction for a sheet P. As illustrated in FIG. 3, the fixing device 100 includes the preheating portion 102, the chain gripper 66 described above, blowers 160, a ventilation plate 180, and the fixing unit 120 (a fixing portion).

### Preheating Portion

The preheating portion 102 illustrated in FIG. 3 is an example of a non-contact heating portion that heats, in a non-contact manner, a toner image on the front surface of a recording medium. Specifically, the preheating portion 102 has a function of heating, in a non-contact manner, a toner image on the front surface of a sheet P that the chain gripper 66 conveys (i.e., a surface facing the preheating portion 102). The preheating portion 102 is provided on an upstream side of the fixing unit 120 in the conveyance direction for a sheet P (the direction that the arrow C indicates). Note that, although not illustrated, a surface of a sheet P, which faces the preheating portion 102, serves as the first surface, or serves as a second surface when the reversing mechanism 80 has reversed the sheet P.

The preheating portion 102 is disposed on the downstream side of the secondary transfer position NT (see FIG. 1) in the conveyance direction for a sheet P to face a surface, which faces upward, of the sheet P that the chain gripper 66 conveys. Specifically, the preheating portion 102 includes a plurality of (for example, three) heating units that are each able to operate independently, which are a first heating unit 102A, a second heating unit 102B, and a third heating unit 102C. In the first exemplary embodiment, the first heating unit 102A, the second heating unit 102B, and the third heating unit 102C are disposed in this order from the upstream side in the conveyance direction for a sheet P. The first heating unit 102A, the second heating unit 102B, and the third heating unit 102C are each provided with a reflecting plate 104, a plurality of heaters 106 (heating sources), and a piece of wire net 112.

In the first heating unit 102A, the second heating unit 102B, and the third heating unit 102C, the heaters 106 are separately controlled and turned ON and OFF, that is, heating and non-heating are independently controlled. In other words, the first heating unit 102A, the second heating unit 102B, and the third heating unit 102C are examples of heat amount changing portions that each change a heat amount to be applied from the preheating portion 102 to a toner image on a sheet P. For example, it is possible to allow all of the first heating unit 102A, the second heating unit 102B, and the third heating unit 102C to operate, or it is possible to allow two of the first heating unit 102A, the second heating unit 102B, and the third heating unit 102C to operate (for example, the second heating unit 102B and the third heating unit 102C, which lie on a side closer to the fixing unit 120).

The reflecting plate 104 has a function of reflecting infrared rays from the heaters 106 toward a lower side of the device (to a side where a sheet P that the chain gripper 66 conveys lies). A metal plate such as an aluminum plate is used to form the reflecting plate 104, for example. The reflecting plate 104 is formed into a box shape that is opened toward the lower side of the device.

The heaters 106 are infrared heaters each having a circular column shale having a length in the front-rear direction of the device. In each of the first heating unit 102A, the second heating unit 102B, and the third heating unit 102C, the plurality of (for example, six) heaters 106 are arranged in parallel to each other inside the reflecting plate 104 in the width direction of the device. Although not illustrated, the heaters 106 each include a carbon filament and a cylindrical quartz tube that accommodates the carbon filament, for example. A surface temperature of each of the heaters 106 in the preheating portion 102 is set to a predetermined temperature ranging from 300 [° C.] or higher to 1175 [° C.] or lower, for example.

The piece of wire net 112 is fixed to an edge portion at an opening on a lower side of the reflecting plate 104. Thus, the piece of wire net 112 separates an interior of the reflecting plate 104 and an exterior of the reflecting plate 104 from each other. Then, the piece of wire net 112 prevents a sheet P that the chain gripper 66 conveys from coming into contact with each of the heaters 106.

As the pieces of chain 72 move in a circulation manner in the direction that the arrow C indicates in a state where one of the grippers 76 holds the front end portion of a sheet P, as described above, the chain gripper 66 conveys the sheet P while causing the surface, which faces upward, of the sheet P to face the first heating unit 102A, the second heating unit 102B, and the third heating unit 102C in the preheating portion 102. That is, the chain gripper 66 is an example of a conveyance portion that conveys a sheet P while causing the surface, which faces upward, of the sheet P to face the preheating portion 102. Note that, in conveyance by the chain gripper 66, a rear end side of the sheet P is not held and is in a free state.

Furthermore, the chain gripper 66 has a function of conveying a sheet P from the preheating portion 102 to the fixing unit 120. As described above, the chain gripper 66 functions as an example of a conveyance portion in the fixing device 100, in a portion having a function of causing, to pass through a heating region in the preheating portion 102, and conveying a sheet P from the preheating portion 102 to the fixing unit 120.

### Blowers

The blowers 160 illustrated in FIG. 3 each have a function of blowing air to a surface, which lies on a side opposite to the preheating portion 102, of a recording medium that the conveyance portion conveys. A plurality of the blowers 160 are disposed in an inside (an inner circumferential side) of a space that the pieces of chain 72 form when viewed in the front-rear direction of the device and below the preheating portion 102. The plurality of blowers 160 are disposed in a two dimensional shape (in a matrix shape) in the conveyance direction for a sheet P and the front-rear direction of the device.

As illustrated in FIG. 3, the blowers 160 face upward and are configured to blow air upward. That is, air is blown in a thickness direction of a sheet P only to the surface, which faces downward, of the sheet P that the chain gripper 66 conveys in a state of facing the preheating portion 102.

As an example, axial flow blowers that blow air in an axial direction are used as the blowers 160. Note that, as the blowers 160, centrifugal blowers that blow air in a centrifugal direction, such as multi-blade blowers (for example, sirocco fans), may be used.

As the blowers 160 blow air toward the surface, which faces downward, of a sheet P that the chain gripper 66 conveys, the sheet P is lifted. Thus, the surface, which faces downward, of the sheet P is brought into a non-contact state. Therefore, the blowers 160 each have a function of allowing the chain gripper 66 to convey a sheet P with the surface, which faces downward, of the sheet P in a non-contact state and maintaining the non-contact state. Furthermore, the blowers 160 supply air only toward the surface, which faces downward, of a sheet P, suppressing such an event that toners transferred on the surface, which faces upward, of the sheet P are cooled.

### Ventilation Plate

The ventilation plate 180 illustrated in FIG. 3 allows air blown from an air blowing portion toward the back surface of a recording medium to pass through. Specifically, the ventilation plate 180 is a plate on which a plurality of ventilation holes 182 are formed to allow air blown from the blowers 160 toward the surface, which faces downward, of a sheet P to pass through.

The ventilation plate 180 is disposed in the inside (the inner circumferential side) of the space that the pieces of chain 72 form when viewed in the front-rear direction of the device and below the preheating portion 102 and above the blowers 160, when the upper-lower direction of the device serves as its thickness direction. That is, it is disposed to cover the blowers 160 on a side in a blowing direction of the blowers 160.

Each of the ventilation holes 182 passes through the ventilation plate 180 in the thickness direction. The plurality of ventilation holes 182 are disposed in a two dimensional shape (in a matrix shape) in the conveyance direction for a sheet P and the front-rear direction of the device, for example.

The ventilation plate 180 allows air blown from the blowers 160 to pass through the plurality of ventilation holes 182 and to come into contact with the surface, which faces downward, of a sheet P that the chain gripper 66 conveys.

### Fixing Unit

The fixing unit 120 illustrated in FIG. 3 is an example of a fixing portion that fixes a toner image on a sheet P to the sheet P. Specifically, the fixing unit 120 has a function of coming into contact with a sheet P, heating and pressing the sheet P, and fixing a toner image to the sheet P.

As illustrated in FIG. 3, the fixing unit 120 is disposed on the downstream side, in the conveyance direction (the direction that the arrow C indicates) for the sheet P, of the preheating portion 102. Specifically, the fixing unit 120 includes the heating roll 130, the pressing roll 140, and driven rolls 150.

### Heating Roll

The heating roll 130 illustrated in FIG. 3 is an example of a heating member that heats a toner image held on the front surface of a sheet P. Specifically, the heating roll 130 is disposed on the downstream side in the conveyance direction with respect to the preheating portion 102, and has a function of coming into contact with a sheet P and heating the sheet P. The heating roll 130 is disposed to come into contact with the surface, which faces upward, of a sheet P (i.e., the surface of the sheet P, on which a toner image is formed), when the front-rear direction of the device serves as its axial direction.

As an example, the heating roll 130 includes a base material 132 having a cylindrical shape, a rubber layer 134 formed on an outer circumference of the base material 132, a release layer 136 formed on an outer circumference of the rubber layer 134, and a heater 138 (a heating source) accommodated inside the base material 132. The heater 138 includes a plurality of halogen lamps, for example. Since the heater 138 includes the plurality of halogen lamps, it is possible to change a temperature of the heating roll 130. The heating roll 130 is an example of a heat amount changing portion that changes a heat amount applied to a toner image on the front surface of a sheet P.

### Driven Rolls

The driven rolls 150 illustrated in FIG. 3 are disposed to each come into contact with a region, other than a contact region with a sheet P, on an outer circumferential surface of the heating roll 130, when the front-rear direction of the device serves as its axial direction. Although, as an example, a number of the driven rolls 150 provided is two, it is possible to change the number of the driven rolls 150.

As an example, the driven rolls 150 each include a base material 152 having a cylindrical shape and a heater 154 (a heating source) accommodated inside the base material 152. The driven rolls 150 follow the heating roll 130, rotate, and heat the heating roll 130. Since the driven rolls 150 heat the heating roll 130, and the heating roll 130 itself has the heater 138, a surface temperature of the heating roll 130 reaches a predetermined temperature ranging from 180 [° C.] or higher to 200 [° C.] or lower. It is possible to allow one of the two driven rolls 150 being provided to be heated and allow the other one to be unheated, for example. The driven rolls 150 are examples of heat amount changing portions that change a heat amount applied to a toner image on the front surface of a sheet P.

### Pressing Roll

The pressing roll 140 illustrated in FIG. 3 is an example of a pressing member that applies pressure to a recording medium together with the heating roll 130. Specifically, the pressing roll 140 has a function of pinching a sheet P and pressing the sheet P together with the heating roll 130. The pressing roll 140 is disposed below the heating roll 130, when the front-rear direction of the device serves as its axial direction.

A circumferential length of the pressing roll 140 is set identical to each of disposition intervals at which the grippers 76 serving as examples of gripping portions are disposed on the pieces of chain 72. Furthermore, as illustrated in FIG. 4, a concave portion 148 extending in the front-rear direction of the device is formed on an outer circumferential surface of the pressing roll 140. Then, it is configured that, when one of the grippers 76, which holds the front end side of a sheet P, passes through between the pressing roll 140 and the heating roll 130, the one of the grippers 76 enters the concave portion 148. The pressing roll 140 is an example of a pressure drum having an outer circumferential surface formed with the concave portion 148.

The pressing roll 140 includes a base material 142 having a cylindrical shape, a rubber layer 144 formed on an outer circumference of the base material 142, and a release layer 146 formed on an outer circumference of the rubber layer 144. As an example, the base material 142 is made of metal.

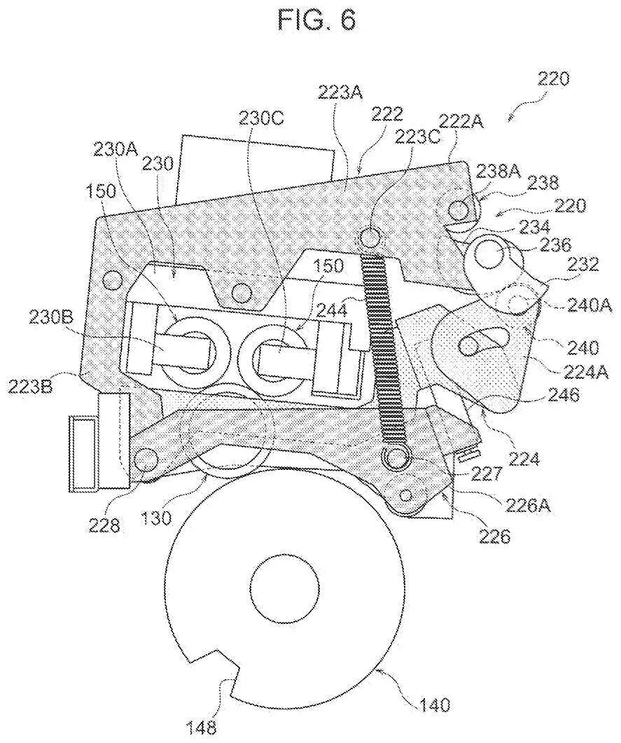

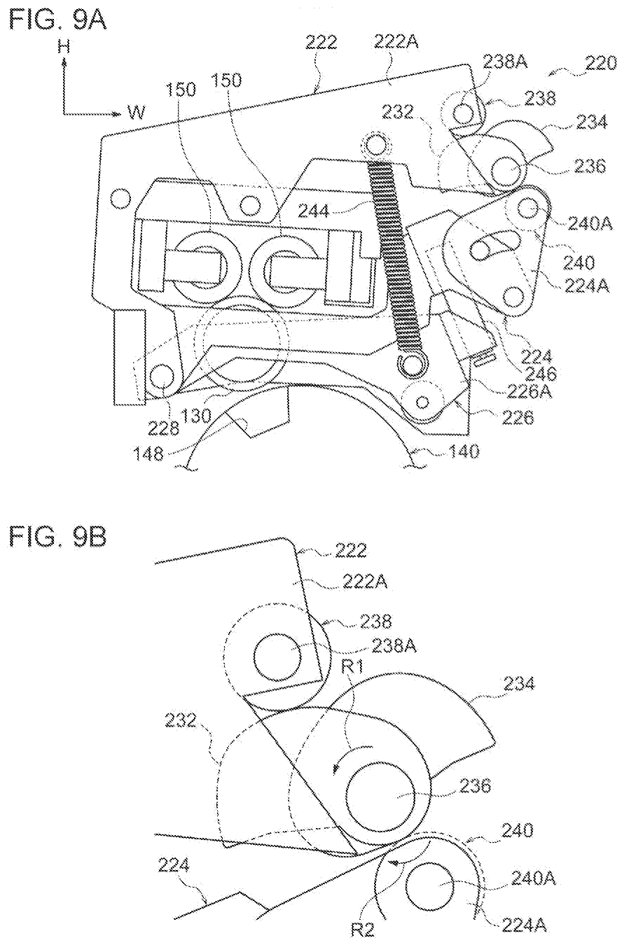

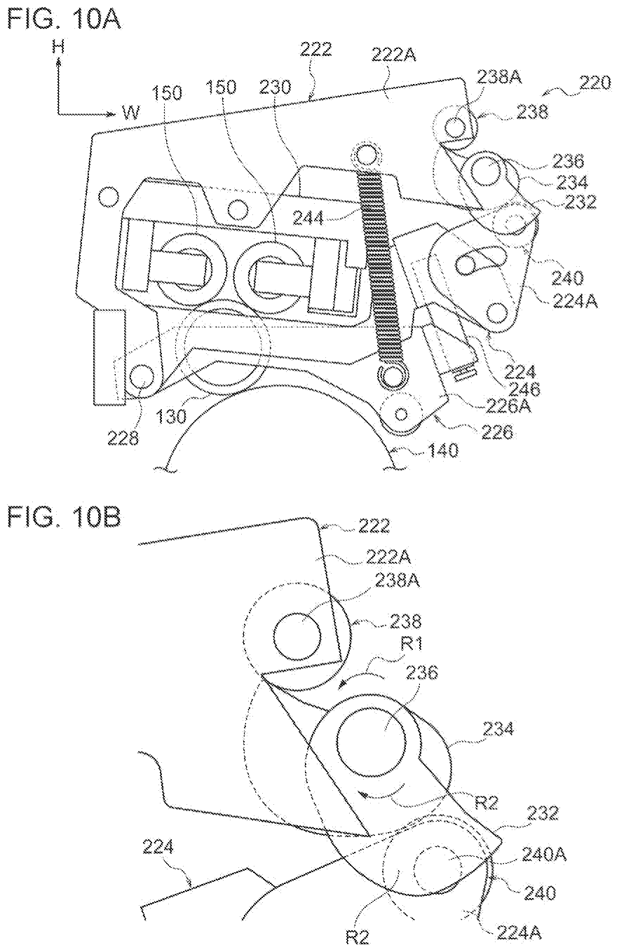

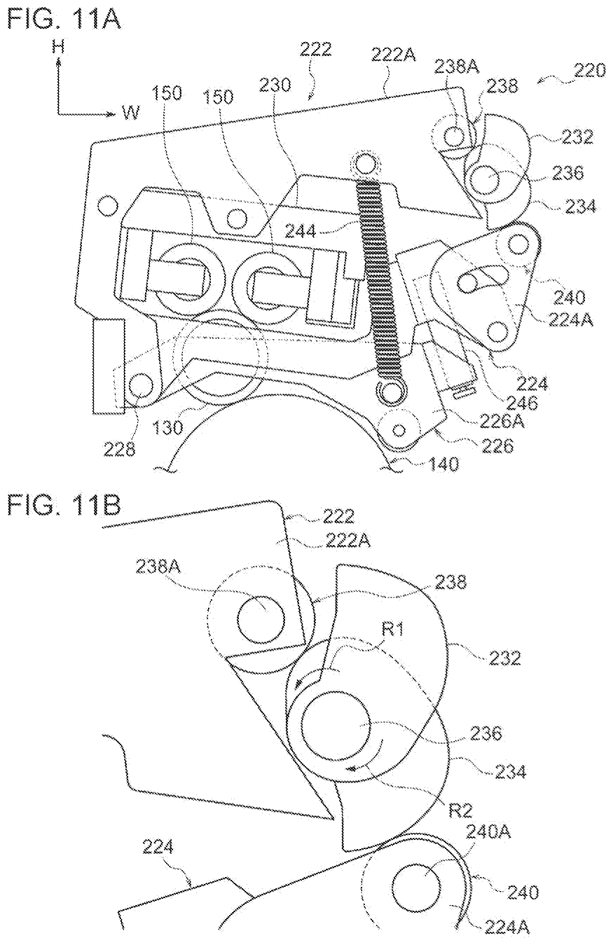

As illustrated in FIG. 6, the fixing unit 120 includes a moving portion 220 that causes the heating roll 130 to relatively move to a position of contact with the pressing roll 140 (see FIGS. 10A and 11A) and a position of separation from the pressing roll 140 (see FIG. 9A). The moving portion 220 includes a first cam 232, a second cam 234, and a camshaft 236 that supports the cams. Furthermore, the second cam 234 is an example of a switching portion that rotates to switch, between high and low, a load to be applied to a contact portion between the heating roll 130 and the pressing roll 140 (see FIGS. 10A and 11A). A configuration of the moving portion 220 will be described later.

Note that, in the fixing unit 120, a drive portion (not illustrated) drives and rotates the pressing roll 140, the heating roll 130 follows the pressing roll 140 and rotates, and the driven rolls 150 follow the heating roll 130 and rotate.

### Cooling Portion

As illustrated in FIG. 1, the cooling portion 90 is disposed on a downstream side of the fixing unit 120 in the conveyance direction for a sheet P (the direction that the arrow C indicates). Furthermore, the cooling portion 90 includes a plurality of (for example, two) cooling rolls 92 arranged in parallel to each other in the width direction of the device.

The cooling rolls 92 are cylindrical rolls made of metal to form a pair of upper and lower rolls to pinch a sheet P and cool the sheet P, for example. As an example, the cooling rolls 92 cool a sheet P in an air cooling manner as air passes through inside the rolls (to exchange heat via air).

### Operation of Image Forming System

Next, operation of the image forming system 10 will now be described herein.

A sheet P sent out of each of the accommodation portions 50 illustrated in FIG. 1 is conveyed by the plurality of conveying rolls 64 and delivered to the chain gripper 66. The sheet P delivered to the chain gripper 66 is conveyed to the secondary transfer position NT by the chain gripper 66 in a state where the front end portion is held by one of the grippers 76, and a toner image is transferred from the transfer belt 31 to the front surface of the sheet P. As illustrated in FIG. 3, the sheet P to which the toner image has been transferred is conveyed by the chain gripper 66 in a state where the front surface of the sheet P faces the heaters 106 in the preheating portion 102, causing the toner image to be heated.

The sheet P on which the toner image has been heated by the preheating portion 102 is further conveyed to the fixing unit 120 by the chain gripper 66, and is pinched, pressed, and heated between the heating roll 130 and the pressing roll 140. Thus, the toner image is fixed to the front surface of the sheet P. When an image is to be formed only on the front surface (i.e., the first surface) of a sheet P, the sheet P on which a toner image has been fixed is cooled by the cooling rolls 92 in the cooling portion 90, and then discharged to the discharge portion 52.

When images are to be formed on both the surfaces of a sheet P (i.e., duplex printing), the sheet P is reversed for the front surface and the back surface by the reversing mechanism 80 illustrated in FIG. 1, and is then again delivered to the chain gripper 66. The sheet P delivered to the chain gripper 66 is conveyed to the secondary transfer position NT as the sheet P having fixed with the toner image on the first surface, and another toner image is transferred from the transfer belt 31 to the back surface (i.e., the second surface).

The sheet P having transferred with the other toner image to its back surface (i.e., the second surface) is heated by the preheating portion 102, and is then pinched, pressed, and heated between the heating roll 130 and the pressing roll 140, causing the other toner image to be fixed to the sheet P. In the preheating portion 102, at this time, the blowers 160 blow air toward the first surface of the sheet P that is conveyed by the chain gripper 66, and the blowers 160 allow the sheet P to be conveyed with the first surface of the sheet P in the non-contact state and maintain the non-contact state. The sheet P on which the toner images are fixed is cooled by the cooling rolls 92 in the cooling portion 90, and is then discharged to the discharge portion 52.

### Hardware Configuration of Fixing Device

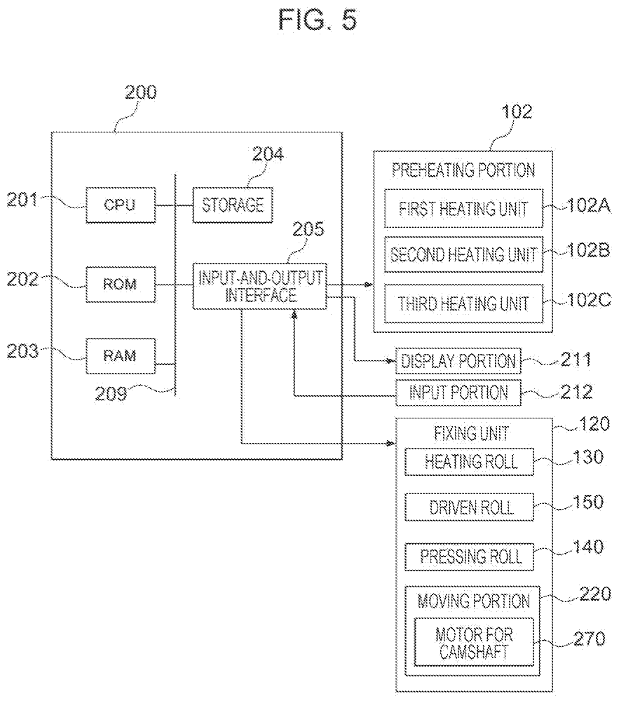

FIG. 5 is a block diagram illustrating a hardware configuration of the fixing device 100. As illustrated in FIG. 5, the fixing device 100 includes the control device 200, the preheating portion 102, the fixing unit 120, a display portion 211, and an input portion 212 as described above. The preheating portion 102 includes the three heating units that are the first heating unit 102A, the second heating unit 102B, and the third heating unit 102C. The fixing unit 120 includes the heating roll 130, the driven rolls 150, the pressing roll 140, and the moving portion 220. The moving portion 220 includes a motor 270 for camshaft for rotating the camshaft 236.

The control device 200 includes a central processing unit (CPU) 201, a read only memory (ROM) 202, a random access memory (RAM) 203, a storage 204, and an input-and-output interface 205. The components are communicably coupled to each other via a bus 209.

The CPU 201 is a central arithmetic processing unit, and executes various types of programs and controls each component. The CPU 201 is an example of a processor. That is, the CPU 201 reads the programs from the ROM 202 or the storage 204, and uses the RAM 203 as a working region to execute the programs. The CPU 201 controls the components described above and performs various types of arithmetic processing in accordance with the programs recorded in the ROM 202 or the storage 204. In the present exemplary embodiment, an information processing program is stored in the ROM 202 or the storage 204.

The ROM 202 stores various types of programs and various types of data. The RAM 203 serves as the working region and temporarily stores a program or a piece of data. The storage 204 includes a hard disk drive (HDD) or a solid state drive (SSD), and stores various types of programs including an operating system and various types of data. The storage 204 stores a program of a printer driver. The CPU 201 reads the program of the printer driver from the storage 204, executes the program, and functions as the printer driver.

The input-and-output interface 205 is an interface for communicating with each device mounted on the fixing device 100. The control device 200 is coupled to the display portion 211, the input portion 212, the preheating portion 102, and the fixing unit 120 via the input-and-output interface 205. Note that the display portion 211, the input portion 212, the preheating portion 102, and the fixing unit 120 may be directly coupled to each other via the bus 209.

The display portion 211 displays various types of information for forming an image. For example, the display portion 211 displays a screen indicating a type of a recording medium and a required image quality mode. Examples of the type of the recording medium include plain paper, thick paper, embossed paper, thin paper, and film member. Furthermore, other examples of the type of the recording medium include coating paper (for example, coated paper) and non-coated paper, indicating whether or not front surfaces are coated with a coating material. Examples of the image quality mode include a high gloss mode under which increased gloss is set, a normal gloss mode under which normal gloss is set, a high quality mode under which increased image quality is set, and a normal quality mode under which normal image quality is set. Gloss used in here refers to a degree of gloss of an image fixed to a sheet P.

The input portion 212 receives an input of a type of a recording medium and an instruction or a selection of an image quality mode by the user, for example. As an example, the display portion 211 is a liquid crystal display, and the input portion 212 applies a touch panel style to receive an input performed on a display screen displaying various types of information, which is displayed on the display portion 211, for example. Note that the input portion 212 may receive an input of information, which is performed through a keyboard operation. The information inputted from the input portion 212 is sent to the CPU 51 via the input-and-output interface 205. Furthermore, the inputted information may be stored in the storage 204, for example.

The CPU 51 controls operation of each of the first heating unit 102A, the second heating unit 102B, and the third heating unit 102C in the preheating portion 102. The CPU 51 changes, in accordance with a type of a sheet P or a selection by the user, a heat amount to be applied from the preheating portion 102 to a toner image on the sheet P. As an example, to increase a heat amount to be applied from the preheating portion 102 to a toner image on the front surface of a sheet P, all of the three heating units, which are the first heating unit 102A, the second heating unit 102B, and the third heating unit 102C, are operated. Furthermore, as an example, to reduce a heat amount to be applied from the preheating portion 102 to a toner image on the front surface of a sheet P, the two heating units, which are the second heating unit 102B and the third heating unit 102C, which are disposed on the side closer to the fixing unit 120, are operated.

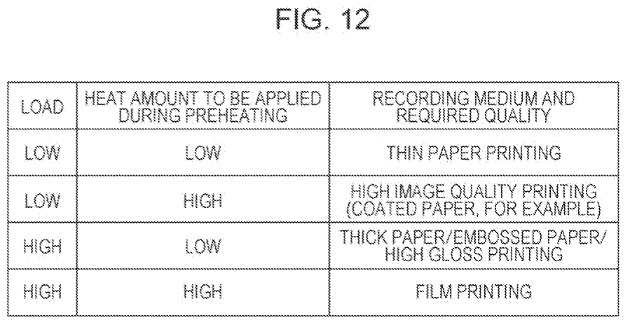

FIG. 12 illustrates a relationship among a load to be applied to the contact portion between the heating roll 130 in the fixing unit 120 and the pressing roll 140, a heat amount that the preheating portion 102 applies during preheating, and a type of a recording medium to be used and required quality. In a case of thin paper printing using a piece of thin paper as a type of a recording medium, thick paper printing using a piece of thick paper, or embossed paper printing using a piece of embossed paper, as illustrated in FIG. 12, a heat amount that the preheating portion 102 applies during preheating is reduced. Furthermore, in a case of high gloss printing, for the required quality, a heat amount that the preheating portion 102 applies during preheating is reduced. Furthermore, in a case of high quality printing using a piece of coated paper as a type of a recording medium or film printing using a film member, a heat amount that the preheating portion 102 applies during preheating is increased. As an example, the CPU 201 causes, in accordance with a type of a recording medium or a mode that the user has selected, which is inputted via the input portion 212, the preheating portion 102 to control the first heating unit 102A, the second heating unit 102B, and the third heating unit 102C to change a heat amount to be applied during preheating.

For example, as illustrated in FIG. 12, when the user selects the high image quality mode via the input portion 212, the CPU 201 increases a heat amount to be applied from the preheating portion 102 to a toner image on the front surface of a sheet P. Furthermore, when the user selects the high gloss mode via the input portion 212, the CPU 201 reduces a heat amount to be applied from the preheating portion 102 to a toner image on the front surface of a sheet P.

Furthermore, as illustrated in FIG. 5, the CPU 201 controls the moving portion 220 in the fixing unit 120. Specifically, rotation of the motor 270 for the camshaft 236 is controlled in the moving portion 220 to move a position of the heating roll 130 relative to the pressing roll 140. For example, the motor 270 is caused to rotate the second cam 234 to switch, between high and low, a load to be applied to the contact portion between the heating roll 130 and the outer circumferential surface of the pressing roll 140.

As an example, the CPU 201 causes, in accordance with a type of a recording medium or a selection by the user, which is inputted via the input portion 212, the motor 270 to rotate the second cam 234 to switch, between high and low, a load to be applied to the contact portion between the heating roll 130 and the outer circumferential surface of the pressing roll 140. As illustrated in FIG. 12, the CPU 201 reduces a load to be applied to the contact portion between the heating roll 130 and the outer circumferential surface of the pressing roll 140 in a case of thin paper printing. Furthermore, the CPU 201 reduces, when a piece of coated paper is used or when the user has selected the high image quality mode via the input portion 212, a load to be applied to the contact portion between the heating roll 130 and the outer circumferential surface of the pressing roll 140.

Furthermore, in a case of thick paper printing or embossed paper printing, the CPU 201 increases a load to be applied to the contact portion between the heating roll 130 and the outer circumferential surface of the pressing roll 140. Furthermore, in a case of film printing or when the user has selected the high gloss mode via the input portion 212, the CPU 201 increases a load to be applied to the contact portion between the heating roll 130 and the outer circumferential surface of the pressing roll 140.

As an example, the ROM 202 or the storage 204 stores such a table as illustrated in FIG. 12, indicating a relationship between a load to be applied to the contact portion between the heating roll 130 in the fixing unit 120 and the pressing roll 140, a heat amount that the preheating portion 102 applies, and a type of a recording medium and required quality. The CPU 51 controls the preheating portion 102 and the fixing unit 120 based on this table.

Furthermore, although not illustrated, the CPU 201 may control the heater 138 in the heating roll 130 or the heater 154 in the two driven rolls 150 to change a temperature of the heating roll 130 in accordance with a type of a recording medium or a selection by the user. For example, in a case of thin paper printing, thick paper printing, embossed paper printing, or high gloss printing, a temperature of the heating roll 130 may be lowered. For example, in a case of high quality printing on a piece of coated paper or film printing, a temperature of the heating roll 130 may be increased.

### Configuration of Moving Portion in Fixing Unit

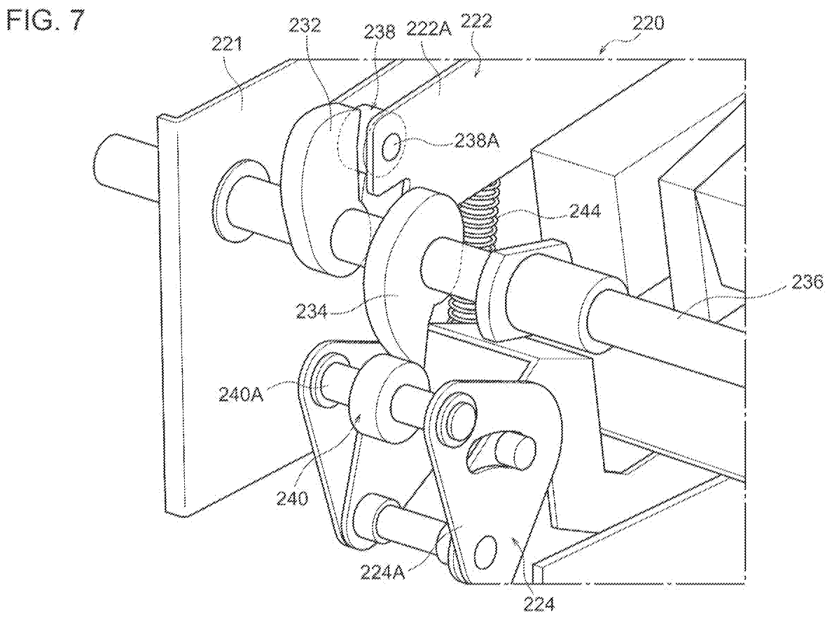

FIG. 6 is a front view illustrating the moving portion 220 in the fixing unit 120. Furthermore, FIG. 7 is a perspective view illustrating a configuration around the camshaft 236 in the moving portion 220.

As illustrated in FIG. 6, the moving portion 220 includes an upper lever 222, an intermediate lever 224, and a lower lever 226, which are disposed in this order from an upper side in the upper-lower direction to a lower side in the upper-lower direction. Furthermore, the moving portion 220 includes a rotation shaft 228 that rotatably supports the upper lever 222, the intermediate lever 224, and the lower lever 226. The rotation shaft 228 is provided on a side closer to the heating roll 130 and at a portion where end portions of the upper lever 222, the intermediate lever 224, and the lower lever 226 overlap with each other. The rotation shaft 228 and a shaft portion of the pressing roll 140 are supported by a frame (not illustrated) of the fixing unit 120, where a position of a rotation center of the rotation shaft 228 and a position of a rotation center of the pressing roll 140 do not change. Therefore, the rotation center of the rotation shaft 228 does not change in position with respect to the rotation center of the pressing roll 140.

As illustrated in FIGS. 6 and 7, the moving portion 220 includes the first cam 232, the second cam 234, and the camshaft 236 to which the first cam 232 and the second cam 234 are attached. The camshaft 236 is disposed between a tip end portion 222A of the upper lever 222 and a tip end portion 224A of the intermediate lever 224 (see FIG. 6). The camshaft 236 is rotatably supported by a frame 221 of the fixing unit 120, and a position of a rotation center of the camshaft 236 does not change (see FIG. 7). That is, the rotation center of the camshaft 236 does not change in position with respect to the rotation center of the pressing roll 140. The motor 270 drives and rotates the camshaft 236 (see FIG. 5).

The upper lever 222 is an L-shaped member when viewed from a front side, as illustrated in FIG. 6, and includes an upper piece portion 223A extending in the horizontal direction on an upper portion of the fixing unit 120 and a vertical piece portion 223B extending downward from one end of the upper piece portion 223A. An end portion of the upper piece portion 223A, which lies opposite to the vertical piece portion 223B, is the tip end portion 222A. The rotation shaft 228 is provided at an end portion (i.e., a lower end portion) of the vertical piece portion 223B, which lies opposite to the tip end portion 222A. The tip end portion 222A of the upper lever 222 is disposed obliquely above the rotation shaft 228.

The two driven rolls 150 are rotatably supported by the upper lever 222 via an attachment member 230. Specifically, the attachment member 230 includes a support piece 230A fixed to the upper lever 222 and two arms 230B and 230C extending from the support piece 230A. The driven rolls 150 are rotatably supported by the two arms 230B and 230C, respectively.

As illustrated in FIGS. 6 and 7, a first cam follower 238 having a circular shape, with which the first cam 232 is able to come into contact, is provided at the tip end portion 222A of the upper lever 222. A shaft portion 238A of the first cam follower 238 is rotatably supported by the tip end portion 222A of the upper lever 222.

The intermediate lever 224 extends obliquely upward from a position around the rotation shaft 228, and the tip end portion 224A of the intermediate lever 224 is disposed above the rotation shaft 228 (see FIG. 6). A second cam follower 240 having a circular shape, with which the second cam 234 is able to come into contact, is provided at the tip end portion 224A of the intermediate lever 224. A shaft portion 240A of the second cam follower 240 is rotatably supported by the tip end portion 224A of the intermediate lever 224.

The lower lever 226 extends in the horizontal direction from a portion where the rotation shaft 228 is provided. The heating roll 130 is rotatably supported at a position, which is closer to the rotation shaft 228, on the lower lever 226.

A tension spring 244 is provided between a tip end portion 226A of the lower lever 226 and the tip end portion 222A of the upper lever 222. One end of the tension spring 244 is hooked on a projection 227 provided to the tip end portion 226A of the lower lever 226, and another end of the tension spring 244 is hooked on a projection 223C provided to the tip end portion 222A of the upper lever 222. As the tension spring 244 pulls the lower lever 226 and the upper lever 222, the heating roll 130 supported by the lower lever 226 and the two driven rolls 150 supported by the upper lever 222 come into contact with each other.

Furthermore, a compression spring 246 is provided to the tip end portion 226A of the lower lever 226 and the tip end portion 224A of the intermediate lever 224. One end of the compression spring 246 is supported by an attachment portion of the tip end portion 226A of the lower lever 226, and another end of the compression spring 246 is supported by an attachment portion of the tip end portion 224A of the intermediate lever 224. With rotation of the second cam 234, the intermediate lever 224 causes a compression state of the compression spring 246 to change via the second cam follower 240 that is in contact with the second cam 234, making it possible to switch, between high and low, a load to be applied to the contact portion between the heating roll 130 and the pressing roll 140. That is, the second cam 234 functions as a switching portion that switches, between high and low, a load to be applied to the contact portion between the heating roll 130 and the pressing roll 140.

For example, as a portion around a portion having a maximum length in radius of the second cam 232 is caused to come into contact with the second cam follower 240, the intermediate lever 224 provided with the second cam follower 240 compresses and pushes down the compression spring 246. Thus, a load to be applied to the contact portion between the heating roll 130 and the pressing roll 140 increases (see FIG. 11A). Note that, although not illustrated, the camshaft 236 is provided with two sensors for detecting a position of the first cam 232 and a position of the second cam 234 to detect the position of the first cam 232 and the position of the second cam 234 using signals from the two sensors.

### Operation of Moving Portion in Fixing Unit

Next, operation of the moving portion 220 in the fixing unit 120 will now be described herein.

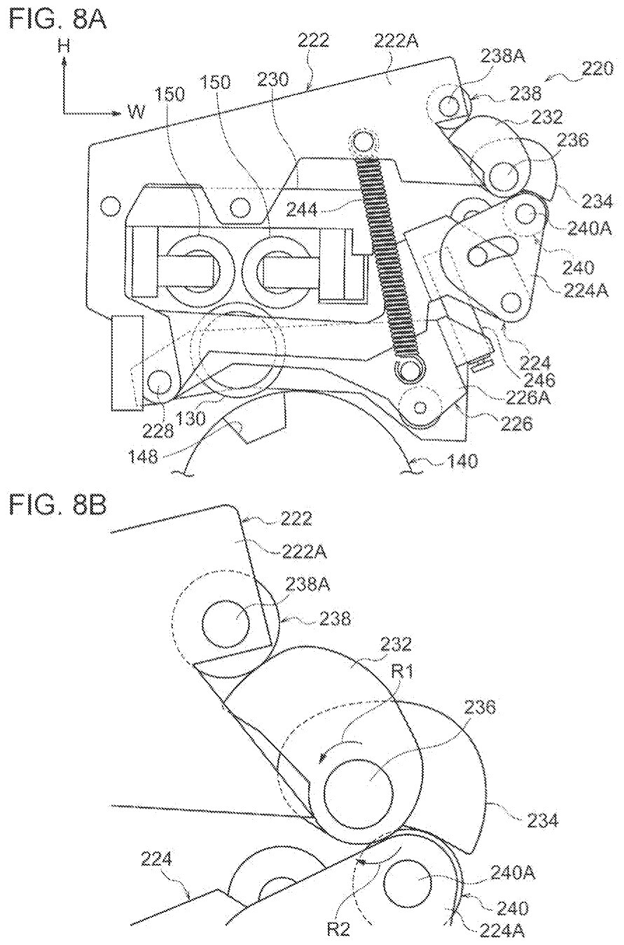

FIG. 8A is a front view illustrating an arrangement when the fixing unit 120 is in a full separation state, that is, when all of the pressing roll 140, the heating roll 130, and the driven rolls 150 are separated from each other. FIG. 8B is an enlarged view illustrating a situation around the camshaft 236 when the fixing unit 120 is in the full separation state. As an example, all of the pressing roll 140, the heating roll 130, and the driven rolls 150 are separated from each other when the fixing unit 120 is to be stopped.

To cause the heating roll 130 to come into contact with the pressing roll 140, the camshaft 236 is rotated in a direction that an arrow R1 indicates, and, to cause the heating roll 130 to move away (i.e., to be retracted) from the pressing roll 140, the camshaft 236 is rotated in a direction that an arrow R2 indicates (see FIG. 8B).

When the fixing unit 120 is in the full separation state, as illustrated in FIGS. 8A and 8B, rotation of the camshaft 236 causes a portion around a portion having a maximum length in radius of the first cam 232 to come into contact with the first cam follower 238 of the upper lever 222. Thus, the first cam follower 238 of the upper lever 222 is pushed to the first cam 232, and the upper lever 222 is pushed upward with respect to the pressing roll 140, allowing the two driven rolls 150 to move away from the heating roll 130.

At this time, the tension spring 244 pulls upward the lower lever 226, and the second cam follower 240 of the intermediate lever 224 is in contact with the second cam 234 via the compression spring 246. As the tension spring 244 pulls upward the lower lever 226, the heating roll 130 is caused to move away from the pressing roll 140.

FIG. 9A is a front view illustrating an arrangement when the fixing unit 120 is in a home position, and FIG. 9B is an enlarged view illustrating a situation around the camshaft 236 when the fixing unit 120 is in the home position. As illustrated in FIGS. 9A and 9B, with rotation of the camshaft 236, a portion having an intermediate length in radius of the first cam 232 is caused to come into contact with the first cam follower 238 of the upper lever 222. Thus, the tension spring 244 pulls the lower lever 226 and the upper lever 222, causing the heating roll 130 supported by the lower lever 226 and the two driven rolls 150 supported by the upper lever 222 to come into contact with each other. At this time, a shorter portion in radius of the second cam 234 faces the second cam follower 240, and the second cam 234 and the second cam follower 240 are not in contact with each other. Therefore, the intermediate lever 224 is not pushed downward, and the heating roll 130 supported by the lower lever 226 and the pressing roll 140 are not in contact with each other.

In the first exemplary embodiment, as the pressing roll 140 rotates, and the concave portion 148 on the pressing roll 140 passes through a position facing the heating roll 130, the heating roll 130 is caused to move to a position separated from the outer circumferential surface of the pressing roll 140. The heating roll 130 illustrated in FIG. 9A is in a state where it has moved to a position separated from the outer circumferential surface of the pressing roll 140. Note that, to make a movement from the full separation state illustrated in FIG. 8A to the home position where the driven rolls 150 are in contact with the heating roll 130 (FIG. 9A), the camshaft 236 is caused to rotate in the direction that the arrow R1 indicates. Furthermore, to make a movement from a state where the heating roll 130 and the pressing roll 140 are in contact with each other to a state where the heating roll 130 and the pressing roll 140 are separated from each other (see FIG. 10A, for example), the camshaft 236 is caused to rotate in the direction that the arrow R2 indicates.

FIG. 10A is a front view illustrating an arrangement when a low load is applied in the fixing unit 120, and FIG. 10B is an enlarged view illustrating a situation around the camshaft 236 when the low load is applied in the fixing unit 120. As illustrated in FIGS. 10A and 10B, with rotation of the camshaft 236, a portion having an intermediate length in radius of the second cam 234 comes into contact with the second cam follower 240 of the intermediate lever 224. Thus, the second cam 234 pushes down the intermediate lever 224 relative to the position of the intermediate lever 224 illustrated in FIGS. 9A and 9B, pushing down the lower lever 226 via the compression spring 246. Thus, the compression spring 246 being compressed pushes the heating roll 130 rotatably supported by the lower lever 226 to the pressing roll 140. At this time, since the portion having the intermediate length in radius of the second cam 234 is in contact with the second cam follower 240 of the intermediate lever 224, the heating roll 130 comes into contact with the pressing roll 140 with a low load.

At this time, the first cam 232 is not in contact with the first cam follower 238 of the upper lever 222. Furthermore, the first cam follower 238 of the upper lever 222 and the camshaft 236 differ from each other in position in the axial direction, and the second cam 234 does not come into contact with the first cam follower 238 (see FIG. 7).

Note that, when making a movement from the arrangement when the low load is applied, as illustrated in FIGS. 10A and 10B, to the home position where the heating roll 130 is separated from the pressing roll 140, as illustrated in FIGS. 9A and 9B, the camshaft 236 is rotated in the direction that the arrow R2 indicates, as described above.

FIG. 11A is a front view illustrating an arrangement when a high load is applied in the fixing unit 120, and FIG. 11B is an enlarged view illustrating a situation around the camshaft 236 when the high load is applied in the fixing unit 120. As illustrated in FIGS. 11A and 11B, with rotation of the camshaft 236 in the direction that the arrow R1 indicates, the portion having the maximum length in radius of the second cam 234 comes into contact with the second cam follower 240 of the intermediate lever 224. Thus, the second cam 234 further pushes down the intermediate lever 224 relative to the position of the intermediate lever 224 illustrated in FIGS. 10A and 10B, and, as an amount of compression by the compression spring 246 increases, the heating roll 130, which is rotatably supported by the lower lever 226, is pushed to the pressing roll 140 with a high load.

At this time, the first cam 232 is not in contact with the first cam follower 238 of the upper lever 222.

Note that, when making a movement from the arrangement when the high load is applied, which is illustrated in FIGS. 11A and 11B, to the home position where the heating roll 130 is separated from the pressing roll 140, as illustrated in FIGS. 9A and 9B, the camshaft 236 is rotated in the direction that the arrow R2 indicates.

### Effects of First Exemplary Embodiment

Next, effects of the first exemplary embodiment will now be described herein.

In the fixing device 100, a sheet P is pressed between the heating roll 130 and the pressing roll 140, and heat from the heating roll 130 is used to heat a toner image on the front surface of the sheet P. The concave portion 148 into which each of the grippers 76 that each grip the front end portion of a sheet P enters is formed on the outer circumferential surface of the pressing roll 140. The moving portion 220 makes a relative movement between a position where the heating roll 130 comes, directly or via the sheet P, into contact with the outer circumferential surface of the pressing roll 140 (see FIGS. 10A and 11A) and a position where the heating roll 130 moves away from the outer circumferential surface of the pressing roll 140 when the concave portion 148 passes (see FIG. 9A).

The CPU 201 in the control device 200 causes the motor 270 to rotate the camshaft 236 in accordance with a type of a sheet P or a selection by the user. Thus, with rotation of the second cam 234, a load to be applied to the contact portion between the heating roll 130 and the outer circumferential surface of the pressing roll 140 is switched between high and low (see FIGS. 10A and 11A).

In a fixing device in an image forming system, generally, fluctuation in speed of a pressing roll, which occurs when a heating roll comes into contact with or moves away from the pressing roll, may be propagated to a transfer belt 31 via a chain gripper 66 and a counter roll 36, resulting in impulse banding. Impulse banding refers to disturbance in an image due to an impact.

Although, in the fixing device, reducing a load to be applied when the heating roll is caused to come into contact with the pressing roll makes it possible to suppress impulse banding that occurs due to fluctuation in speed of the chain gripper 66, there are issues of securing fixity on a thick sheet P and gloss control. For example, low pressure at which the heating roll is caused to come into contact with the pressing roll may make difficult to secure fixing of a toner image on a piece of thick paper or embossed paper. Furthermore, a higher load applied to the contact portion between the heating roll and the pressing roll may increase gloss, and a lower load applied to the contact portion between the heating roll and the pressing roll may reduce gloss, making it difficult to control gloss.

In the fixing device 100 according to the first exemplary embodiment, the moving portion 220 makes a movement, when the concave portion 148 on the pressing roll 140 passes, to a position where the heating roll 130 moves away from the outer circumferential surface of the pressing roll 140 (see FIGS. 10A and 11A). Thus, it is suppressed that fluctuation in speed of the pressing roll 140, which occurs when the heating roll 130 comes into contact with and moves away from the pressing roll 140 is propagated to the chain gripper 66. Furthermore, in the fixing device 100, a load to be applied to the contact portion between the heating roll 130 and the outer circumferential surface of the pressing roll 140 is switched between high and low with rotation of the second cam 234 in accordance with a type of a sheet P or a selection by the user.

For example, in a case of thin paper printing or high quality printing for a piece of coated paper, a load to be applied to the contact portion between the heating roll 130 and the outer circumferential surface of the pressing roll 140 is reduced, as illustrated in FIG. 12. For example, in a case of high gloss printing, thick paper printing, embossed paper printing, or film printing, a load to be applied to the contact portion between the heating roll 130 and the outer circumferential surface of the pressing roll 140 is increased.

Therefore, the fixing device 100 makes it possible to suppress deterioration of image quality due to vibration that occurs when the heating roll 130 comes into contact with the pressing roll 140 or to secure a fully fixed, high gloss toner image on a sheet P in accordance with a type of the sheet P or required image quality, compared with a case where a load to be applied to the contact portion between the heating roll and the pressing roll is always constant.

Furthermore, in the fixing device 100, a heat amount to be applied to a toner image on the front surface of a sheet P is changed in accordance with a type of the sheet P or a selection by the user. For example, a temperature of the heating roll 130 is changed in accordance with a type of a sheet P or a selection by the user. Therefore, the fixing device 100 makes it possible to secure a fully fixed, high gloss toner image on a sheet P, compared with a case where a heat amount to be applied to a toner image on the front surface of a sheet P is constant.

Furthermore, the fixing device 100 includes, on an upstream side of the heating roll 130 in the conveyance direction for a sheet P, the preheating portion 102 that heats a toner image on the front surface of the sheet P in a non-contact state. Furthermore, the fixing device 100 further includes the chain gripper 66 that conveys a sheet P between the heating roll 130 and the pressing roll 140 while causing the front surface of the sheet P to face the preheating portion 102. Therefore, the fixing device 100 makes it possible to secure a fully fixed high gloss image on a sheet P, compared with a case where the front surface of a sheet P is not heated on an upstream side of a heating roll.

Furthermore, the fixing device 100 includes the first heating unit 102A, the second heating unit 102B, and the third heating unit 102C, which change a heat amount to be applied from the preheating portion 102 to a toner image on the front surface of a sheet P in accordance with a type of the sheet P or a selection by the user. For example, in a case of thin paper printing, high gloss printing, thick paper printing, or embossed paper printing, as illustrated in FIG. 12, the two heating units, which are the second heating unit 102B and the third heating unit 102C, which lie on the side closer to the fixing unit 120, are operated to reduce a heat amount that the preheating portion 102 applies during preheating. For example, in a case of high quality printing on a piece of coated paper or film printing, all of the three heating units, which are the first heating unit 102A, the second heating unit 102B, and the third heating unit 102C, are operated to increase a heat amount that the preheating portion 102 applies during preheating. Therefore, the fixing device 100 makes it possible to secure a fully fixed, high gloss toner image on a sheet P, compared with a case where a heat amount to be applied from the preheating portion to a toner image on the front surface of a sheet P is constant.

Furthermore, when a thickness of a sheet P is equal to or greater than a thickness of a piece of plain paper or when a recording medium is a film member, the fixing device 100 causes the second cam 234 to rotate to increase a load to be applied to the contact portion between the heating roll 130 and the outer circumferential surface of the pressing roll 140 (see FIG. 12). Therefore, the fixing device 100 makes it possible to secure a fully fixed, high gloss toner image on a sheet P, compared with a case where a load to be applied to the contact portion between the heating roll and the outer circumferential surface of the pressing roll is constant, even when a thickness of a sheet P is equal to or greater than a thickness of a piece of plain paper or when a recording medium is a film member.

Furthermore, when the user selects the high gloss mode, the fixing device 100 causes the second cam 234 to rotate to increase a load to be applied to the contact portion between the heating roll 130 and the outer circumferential surface of the pressing roll 140 (see FIG. 12). Therefore, the fixing device 100 makes it possible to secure a fully fixed, high gloss toner image on a sheet P, compared with a case where a load to be applied to the contact portion between the heating roll and the outer circumferential surface of the pressing roll is constant even when a high gloss image is required.

Furthermore, when the user selects the high image quality mode or when a sheet P is less than a piece of plain paper in thickness, the fixing device 100 causes the second cam 234 to rotate to reduce a load to be applied to the contact portion between the heating roll 130 and the outer circumferential surface of the pressing roll 140 (see FIG. 12). Therefore, the fixing device 100 makes it possible to suppress deterioration of image quality due to vibration that occurs when the heating roll 130 comes into contact with the pressing roll 140, compared with a case where a load to be applied to the contact portion between the heating roll and the outer circumferential surface of the pressing roll is constant even when the user selects the high image quality mode or when a sheet P is less than a piece of plain paper in thickness.

Furthermore, when the user selects the high image quality mode or when a recording medium is a film member, the fixing device 100 increases a heat amount to be applied from the preheating portion 102 to a toner image on the front surface of a sheet P (see FIG. 12). Therefore, the fixing device 100 makes it possible to secure a fully fixed, high gloss toner image on a sheet P, compared with a case where a heat amount to be applied to a toner image on the front surface of a recording medium is constant even when high image quality is required or when a recording medium is a film member.

Furthermore, when the user selects the high gloss mode, the fixing device 100 reduces a heat amount to be applied from the preheating portion 102 to a toner image on the front surface of a sheet P. Therefore, the fixing device 100 makes it possible to secure a high gloss toner image on a sheet P, compared with a case where a heat amount to be applied to a toner image on the front surface of a sheet P is constant even when high gloss is required.

Furthermore, the image forming system 10 includes the image forming portion 12 that forms a toner image on a sheet P, the input portion 212 which allows the user to make an input for selecting an image quality mode, and the fixing device 100 that fixes the toner image that the image forming portion 12 has formed to the sheet P. Therefore, the image forming system 10 makes it possible to suppress deterioration of image quality due to vibration that occurs when the heating roll 130 comes into contact with the pressing roll 140 or to secure a fully fixed, high gloss toner image on a sheet P in accordance with a type of the sheet P or required image quality, compared with a case where a load to be applied to the contact portion between the heating roll and the pressing roll is always constant.

### Others

Although a sheet P or a film member has been used as an example of a recording medium in the exemplary embodiment described above, there is no limitation in recording medium. As an example of a recording medium, a sheet material formed into a sheet shape (a paper shape or a film shape) other than a sheet P may be used, for example.

Furthermore, although, in the exemplary embodiment described above, a sheet P is conveyed to the secondary transfer position NT by the chain gripper 66 serving as an example of a conveyance portion, the sheet P is caused to pass through the preheating portion 102, and the sheet P is further conveyed to the fixing unit 120, the present disclosure is not limited to the exemplary embodiment. As an example of a conveyance portion, such a conveyance portion, as a chain gripper, may be applied that receives a sheet P having passed through the secondary transfer position NT, and then allows the sheet P to pass through the preheating portion 102 and to be delivered to the fixing unit 120. In this case, another conveyance portion (for example, a conveying roll) conveys the sheet P to the secondary transfer position NT.

Furthermore, although, in the exemplary embodiment described above, a load to be applied to the contact portion between the heating roll 130 and the outer circumferential surface of the pressing roll 140 and a heat amount that the preheating portion 102 applies during preheating are changed in accordance with a type of a recording medium and required quality, as illustrated in FIG. 12, the present disclosure is not limited to this configuration. For example, it is possible to change a load to be applied to the contact portion between the heating roll 130 and the outer circumferential surface of the pressing roll 140 and conditions for a recording medium and required quality for changing a heat amount that the preheating portion 102 applies during preheating.

It is also possible to achieve the processing described above that the fixing device 100 performs with a dedicated hardware circuit. In this case, the processing may be executed by one piece of hardware or may be executed by a plurality of pieces of hardware.

Furthermore, programs for operating the fixing device 100 may be provided by a computer-readable recording medium such as a universal serial bus (USB) memory, a flexible disk, or a compact disc read only memory (CD-ROM), or may be provided online via a network such as the Internet. In this case, the programs recorded on the computer-readable recording medium are normally transferred to and stored in a memory or a storage, for example. Furthermore, the programs may be provided as independent application software, or may be incorporated into software for each device as one function of the fixing device 100 or the image forming system 10, for example.

Note that, although the specific exemplary embodiment of the present disclosure has been described in detail, the present disclosure is not limited to the exemplary embodiment, and it will be apparent to those skilled in the art that various types of other exemplary embodiments are possible within the scope of the present disclosure.

### Preferred Aspects of Present Disclosure

Appendices on preferred aspects of the present disclosure are given below.
(((1))) A fixing device comprising:
a heating member configured to heat a toner image on a front surface of a recording medium;
a pressing member having an outer circumferential surface formed with a concave portion into which a gripping portion configured to grip a front end side of the recording medium enters, the pressing member being configured to rotate and press the recording medium together with the heating member;
a moving portion configured to cause the heating member and the pressing member to relatively move between a position where the heating member comes into contact with the outer circumferential surface of the pressing member directly or via the recording medium and a position where the heating member moves away from the outer circumferential surface of the pressing member when the concave portion passes; and
a switching portion configured to switch, between high and low, a load to be applied to a contact portion between the heating member and the outer circumferential surface of the pressing member in accordance with a type of the recording medium or a selection by a user.
(((2))) The fixing device according to (((1))), further comprising a heat amount changing portion configured to change a heat amount to be applied to the toner image on the front surface of the recording medium in accordance with a type of the recording medium or a selection by the user.
(((3))) The fixing device according to (((1))) or (((2))), further comprising:
a non-contact heating portion provided on an upstream side of the heating member in a conveyance direction for the recording medium, the non-contact heating portion being configured to heat the toner image on the front surface of the recording medium in a non-contact state; and
a conveyance portion configured to convey the recording medium to a position between the heating member and the pressing member while causing the front surface of the recording medium to face the non-contact heating portion.
(((4))) The fixing device according to (((3))), further comprising a heat amount changing portion configured to change a heat amount to be applied from the non-contact heating portion to the toner image on the front surface of the recording medium in accordance with a type of the recording medium or a selection by the user.
(((5)) The fixing device according to any one of (((1))) to (((4))), wherein, when a thickness of the recording medium is equal to or greater than a thickness of a piece of plain paper or when the recording medium is a film member, the switching portion increases the load to be applied to the contact portion between the heating member and the outer circumferential surface of the pressing member.
(((6))) The fixing device according to any one of (((1))) to (((5))), wherein, when the user selects a high gloss mode, the switching portion increases the load to be applied to the contact portion between the heating member and the outer circumferential surface of the pressing member.
(((7))) The fixing device according to any one of (((1))) to (((6))), wherein, when the user selects a high image quality mode or when a thickness of the recording medium is less than a thickness of a piece of plain paper, the switching portion reduces the load to be applied to the contact portion between the heating member and the outer circumferential surface of the pressing member.
(((8))) The fixing device according to (((2))), wherein, when the user selects a high image quality mode or when the recording medium is a film member, the heat amount changing portion increases the heat amount to be applied to the toner image on the front surface of the recording medium.
(((9))) The fixing device according to (((4))), wherein, when the user selects a high image quality mode or when the recording medium is a film member, the heat amount changing portion increases the heat amount to be applied to the toner image on the front surface of the recording medium.
((10)) The fixing device according to (((4))), wherein, when the user selects a high gloss mode, the heat amount changing portion reduces the heat amount to be applied to the toner image on the front surface of the recording medium.
(((11))) An image forming system comprising:
an image forming portion configured to form a toner image on a recording medium;
an input portion configured to allow a user to select an image quality mode; and
the fixing device according to any one of (((1))) to (((10))), the fixing device being configured to fix the toner image formed by the image forming portion on the recording medium.

What is claimed is:

1. A fixing device comprising:
a heating member configured to heat a toner image on a front surface of a recording medium;
a pressing member having an outer circumferential surface formed with a concave portion into which a gripping portion configured to grip a front end side of the recording medium enters, the pressing member being configured to rotate and press the recording medium together with the heating member;
a moving portion configured to cause the heating member and the pressing member to relatively move between a position where the heating member comes into contact with the outer circumferential surface of the pressing member directly or via the recording medium and a position where the heating member moves away from the outer circumferential surface of the pressing member when the concave portion passes; and
a switching portion configured to switch, between high and low, a load to be applied to a contact portion between the heating member and the outer circumferential surface of the pressing member in accordance with a type of the recording medium or a selection by a user.

2. The fixing device according to claim 1, further comprising a heat amount changing portion configured to change a heat amount to be applied to the toner image on the front surface of the recording medium in accordance with a type of the recording medium or a selection by the user.

3. The fixing device according to claim 1, further comprising:
a non-contact heating portion provided on an upstream side of the heating member in a conveyance direction for the recording medium, the non-contact heating portion being configured to heat the toner image on the front surface of the recording medium in a non-contact state; and
a conveyance portion configured to convey the recording medium to a position between the heating member and the pressing member while causing the front surface of the recording medium to face the non-contact heating portion.

4. The fixing device according to claim 3, further comprising a heat amount changing portion configured to change a heat amount to be applied from the non-contact heating portion to the toner image on the front surface of the recording medium in accordance with a type of the recording medium or a selection by the user.

5. The fixing device according to claim 1, wherein, when a thickness of the recording medium is equal to or greater than a thickness of a piece of plain paper or when the recording medium is a film member, the switching portion increases the load to be applied to the contact portion between the heating member and the outer circumferential surface of the pressing member.

6. The fixing device according to claim 1, wherein, when the user selects a high gloss mode, the switching portion increases the load to be applied to the contact portion between the heating member and the outer circumferential surface of the pressing member.

7. The fixing device according to claim 1, wherein, when the user selects a high image quality mode or when a thickness of the recording medium is less than a thickness of a piece of plain paper, the switching portion reduces the load to be applied to the contact portion between the heating member and the outer circumferential surface of the pressing member.

8. The fixing device according to claim 2, wherein, when the user selects a high image quality mode or when the recording medium is a film member, the heat amount changing portion increases the heat amount to be applied to the toner image on the front surface of the recording medium.

9. The fixing device according to claim 4, wherein, when the user selects a high image quality mode or when the recording medium is a film member, the heat amount changing portion increases the heat amount to be applied to the toner image on the front surface of the recording medium.

10. The fixing device according to claim 4, wherein, when the user selects a high gloss mode, the heat amount changing portion reduces the heat amount to be applied to the toner image on the front surface of the recording medium.

11. An image forming system comprising:
an image forming portion configured to form a toner image on a recording medium;
an input portion configured to allow a user to select an image quality mode; and
the fixing device according to claim 1, the fixing device being configured to fix the toner image formed by the image forming portion on the recording medium.

12. An image forming system comprising:
an image forming portion configured to form a toner image on a recording medium;
an input portion configured to allow a user to select an image quality mode; and
the fixing device according to claim 2, the fixing device being configured to fix the toner image formed by the image forming portion on the recording medium.

13. An image forming system comprising:
an image forming portion configured to form a toner image on a recording medium;
an input portion configured to allow a user to select an image quality mode; and
the fixing device according to claim 3, the fixing device being configured to fix the toner image formed by the image forming portion on the recording medium.

14. An image forming system comprising:
an image forming portion configured to form a toner image on a recording medium;
an input portion configured to allow a user to select an image quality mode; and
the fixing device according to claim 4, the fixing device being configured to fix the toner image formed by the image forming portion on the recording medium.

15. An image forming system comprising:
an image forming portion configured to form a toner image on a recording medium;
an input portion configured to allow a user to select an image quality mode; and
the fixing device according to claim 5, the fixing device being configured to fix the toner image formed by the image forming portion on the recording medium.

16. An image forming system comprising:
an image forming portion configured to form a toner image on a recording medium;
an input portion configured to allow a user to select an image quality mode; and
the fixing device according to claim 6, the fixing device being configured to fix the toner image formed by the image forming portion on the recording medium.

17. An image forming system comprising:
an image forming portion configured to form a toner image on a recording medium;
an input portion configured to allow a user to select an image quality mode; and
the fixing device according to claim 7, the fixing device being configured to fix the toner image formed by the image forming portion on the recording medium.

18. An image forming system comprising:
an image forming portion configured to form a toner image on a recording medium;
an input portion configured to allow a user to select an image quality mode; and
the fixing device according to claim 8, the fixing device being configured to fix the toner image formed by the image forming portion on the recording medium.

19. An image forming system comprising:
an image forming portion configured to form a toner image on a recording medium;
an input portion configured to allow a user to select an image quality mode; and
the fixing device according to claim 9, the fixing device being configured to fix the toner image formed by the image forming portion on the recording medium.

20. An image forming system comprising:
an image forming portion configured to form a toner image on a recording medium;
an input portion configured to allow a user to select an image quality mode; and
the fixing device according to claim 10, the fixing device being configured to fix the toner image formed by the image forming portion on the recording medium.
